(19) United States
(12) Patent Application Publication
(10) Pub. No.: US 2024/0360808 A1
(43) Pub. Date: Oct. 31, 2024

(54) FUEL INJECTOR OF AN INTERNAL COMBUSTION ENGINE AND INTERNAL COMBUSTION ENGINE

(71) Applicant: MAN Energy Solutions SE, Augsburg (DE)

(72) Inventors: Björn DIRUMDAM, Ellgau (DE); Thomas KLAUA, Augsburg (DE)

(21) Appl. No.: 18/644,365

(22) Filed: Apr. 24, 2024

(30) Foreign Application Priority Data
Apr. 26, 2023 (DE) 10 2023 110 724.0

(51) Int. Cl. F02M 61/10; F02M 61/14

(52) U.S. Cl. CPC F02M 61/10; F02M 61/14

(57) ABSTRACT

A fuel injector supplying fuel to a combustion chamber of an internal combustion engine, having a main body, a first nozzle needle moveably guided in a first needle guide, a first needle fuel chamber interacting with the first nozzle needle for a first liquid fuel, coupled to the combustion chamber by first channels. The first channels, via first inner openings, are connected to the first needle fuel chamber, having a second nozzle needle moveably guided in a second needle guide, a second needle fuel chamber interacting with the second nozzle needle for a second liquid fuel, coupled via second channels to the combustion chamber. The second channels are connected via second inner openings to the second needle fuel chamber. The first inner openings are arranged on a first circular contour and the second inner openings on a second circular contour extending concentrically about the first circular contour.

### BACKGROUND OF THE INVENTION

### 1. Field of the Invention

The disclosure relates to a fuel injector of an internal combustion engine and an internal combustion engine having the fuel injector.

### 1. Description of Related Art

Dual-fuel internal combustion engines are already known as marine engines. Dual-fuel internal combustion engines known from practice can be operated in a first operating mode in which the internal combustion engines combust a first fuel, in particular a first liquid relatively ignitable fuel, and in a second operating mode, in which the internal combustion engines combust a second fuel, in particular a gaseous fuel or a second liquid fuel which is relatively less ignitable fuel.

The first liquid relatively ignitable fuel, which is combusted in the first operating mode, can be for example a diesel fuel. The second liquid relatively less ignitable fuel, which is combusted in the second operating mode, can be for example methanol, ethanol, or ammonia. In the second operating mode, methanol, ethanol, or ammonia, which is relatively less ignitable as such, can be ignited via the first liquid fuel utilised in the first operating mode, namely the diesel fuel, which is relatively ignitable.

### SUMMARY OF THE INVENTION

Internal combustion engines known from practice, in which different liquid fuels can be combusted, typically have a separate fuel injector for each liquid fuel. This is disadvantageous since because of this relatively much installation space is required. There is a need for a fuel injector that is suitable for introducing two liquid fuels in into the combustion chamber of a cylinder, which is assigned to the fuel injector.

One aspect of the present invention is based on creating a new type of fuel injector of an internal combustion engine and an internal combustion engine having such a fuel injector.

The present disclosure relates in particular to the field of so-called large engines or large internal combustion engines, the cylinders of which have piston diameters of at least 140 mm, in particular of at least 175 mm. Such large internal combustion engines are for example marine engines.

The fuel injector comprises a main body, a first nozzle needle moveably guided in a first needle guide and a second nozzle needle moveably guided in a second needle guide.

Further, the fuel injector comprises a first needle fuel chamber interacting with the first nozzle needle for a first liquid fuel, which can be coupled via first channels to the combustion chamber of the cylinder, wherein the first channels are connected to the first needle fuel chamber via first internal openings.

Further, the fuel injector comprises a second needle fuel chamber interacting with the second nozzle needle for a second liquid fuel, which can be coupled via second channels to the combustion chamber of the cylinder, wherein the second channels are connected via second internal openings to the second needle fuel chamber.

The first inner openings are arranged on a first circular contour and the second internal openings on a second circular contour extending concentrically about the first circular contour.

The fuel injector according to one aspect of the invention is a multi-needle injector with at least two nozzle needles, wherein each nozzle needle is guided in a respective need guide and interacts with a respective needle fuel chamber. Each needle fuel chamber is connected via channels to the combustion chamber of the cylinder.

In that the first inner openings are arranged on the first circular contour and the second internal openings on the second circular contour extending concentrically about the first circular contour, the fuels can be particularly advantageously introduced into the combustion chamber via the channels, in particular when the introduction of the liquid fuels takes place at least partially at the same time. This then allows a particularly advantageous ignition of the relatively less ignitable liquid fuel via the other relatively ignitable liquid fuel. The fuels can evenly and homogenously spread in the combustion chamber as a result of which an even mixture propagation upon introduction of multiple liquid fuels can be ensured.

Preferentially, a ratio between the diameter of the first circular contour and the diameter of the second circular contour is between 0.1 and 0.5, in particular between 0.2 and 0.3. This is particularly preferred in order to ensure an even mixture propagation of a mixture of multiple liquid fuels introduced into the combustion chamber, in particular when the liquid fuels are introduced into the combustion chamber at least partially at the same time.

Preferentially, the longitudinal centre axes of the first channels run parallel to the longitudinal centre axes of the second channels. Alternatively it can be provided that the longitudinal centre axes of the first channels and the longitudinal centre axes of the second channels, seen in the flow direction through the same, diverge on converge. Depending on the liquid fuels that are to be introduced into the combustion chamber of a cylinder with the help of the fuel injector according to the invention, the orientation of the longitudinal centre axes of the first channels and second channels can be selected.

Preferentially, the second needle fuel chamber is arranged, at least in portions, concentrically about the first needle fuel chamber. This is particularly preferred for supplying the second openings with fuel, originating from the second needle fuel chamber.

Preferentially, the main body comprises a first recess in which a first insert is arranged, wherein the first insert provides the first needle guide for the first nozzle needle, the first needle fuel chamber and the first channels. Preferentially, the main body provides the second needle fuel chamber and the second channels. Preferentially, the main body comprises a second recess in which a second insert is arranged, wherein the second insert provides the second needle guide for the second nozzle needle. This embodiment is advantageous in particular when the fuel injector is composed of multiple individual parts.

Alternatively, a monolithic design of the fuel injector is also possible, which is then produced in particular by 3D printing.

### BRIEF DESCRIPTION OF THE DRAWINGS

Preferred further developments of aspects of the invention are obtained from the following description. Exemplary embodiments of the invention are explained in more detail by way of the drawing without being restricted to this. There it shows:

FIG. 1: is a schematic cross-section through a first fuel injector of a dual-fuel internal combustion engine according to the invention; and

FIG. 2: is a schematic cross-section through a second fuel injector of a dual-fuel internal combustion engine according to the invention.

### DETAILED DESCRIPTION OF THE PRESENTLY PREFERRED EMBODIMENTS

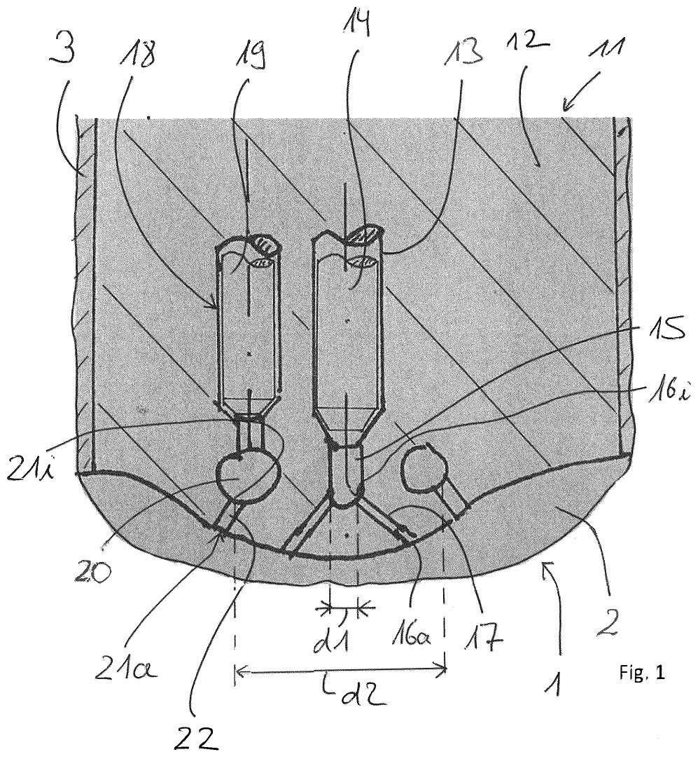

FIG. 1 shows a schematic cross-section through a fuel injector 11 installed in the region of a cylinder 1 of an internal combustion engine, wherein via the fuel injector 11 liquid fuels can be introduced into a combustion chamber 2 of the cylinder 1. The fuel injector 11 has a main body 12 and is installed via the main body 12 in a cylinder head 3 of the cylinder 1.

Further, the fuel injector 11 has a first needle guide 13 with a first nozzle needle 14 moveably guided in the same. A first needle fuel chamber 15, which is connected via the first channels 17 to the combustion chamber 2, interacts with the first nozzle needle 14. The first channels 17 lead via first radial inner openings 16i into the first needle fuel chamber 15 and via first radially outer openings 16a into the combustion chamber 2 of the cylinder 1.

Further, the fuel injector 11 has a second needle guide 18 with a second nozzle needle 19 moveably guided in the same. The second nozzle needle 19 interacts with a second needle fuel chamber 20, which is connected to the combustion chamber 2 via second channels 22. The second channels 22 lead via second radially inner openings 21i into the second needle fuel chamber 20 and via second radially outer openings 21a into the combustion chamber 2 of the cylinder 1.

The first inner openings 16i are arranged on a first circular contour with a first diameter d1. The second inner openings 21i are arranged on a second circular contour with a second diameter d2, wherein the second circular contour extends concentrically about the first circular contour.

The first outer openings 16a are arranged on a third circular contour with a third diameter. The second outer openings 21a are arranged on a fourth circular contour with a fourth diameter, wherein the fourth circular contour extends concentrically about the third circular contour.

In particular, the third circular contour extends concentrically about the second circular contour.

By way of such channels 17, 22, the first liquid fuel and the second liquid fuel can be particularly advantageously introduced into the combustion chamber 2 of the respective cylinder 1, in particular when the two liquid fuels are introduced into the combustion chamber at least partially at the same time, wherein it allows the fuel injector 11 to provide an even, homogeneous mixture between the two liquid fuels within the combustion chamber 2 of the respective cylinder 1.

Particularly advantageous is a configuration, in which a ratio d1/d2 between the first diameter d1 of the first circular contour, on which the first inner openings 16i are arranged, and the second diameter d2 of the second circular contour, on which the second inner openings 21i are arranged, is between 0.4 and 0.9, in particular between 0.5 and 0.8. This is particularly preferred for an even mixture formation of liquid fuels to be at least partially introduced into the combustion chamber 2 at the same time.

The first liquid fuel, which can be introduced into the combustion chamber 2 of the cylinder with the help of the first channels 17, is in particular relatively ignitable diesel fuel. The second liquid fuel, which is introduced into the combustion chamber 2 of the cylinder via the second channels 22, is a relatively less ignitable fuel, in particular methanol, ethanol or even ammonia. This second liquid relatively less ignitable fuel can be advantageously ignited with the help of the first liquid fuel.

The second needle fuel chamber 20 is arranged concentrically about the first needle fuel chamber 15 at least in portions. The second needle fuel chamber 20 is in particular an annular volume, which extends, spaced apart, about the first needle fuel chamber 15. Because of this, the second channels 22, originating from the second needle fuel chamber 20, can be particularly advantageously supplied with fuel.

As already explained, the first channels 17 are connected via the first inner openings 16i to the first needle fuel chamber 15 and the second channels 22 via the second inner openings 21i to the second needle fuel chamber 20. The first and second channels 17, 22 have longitudinal centre axes.

In a first configuration it is provided that the longitudinal centre axes of the first channels 17 and the longitudinal centre axes of the second channels 22 run parallel to one another. Alternatively it is provided that the longitudinal centre axes of the first channels 17 and the longitudinal centre axes of the second channels 22 diverge, alternatively converge seen in the flow direction of the same—i.e. in the direction of the combustion chamber 2 of the cylinder 1.

Dependent on the orientation of the longitudinal centre axes of the channels 17, 22, the mixture formation of the liquid fuels to be introduced into the combustion chamber 2 can be influenced or adjusted.

Longitudinal centre axes of the first channels 17 and second channels 22 converging in the flow direction are advantageously employed in particular when the second liquid fuel, which is to be ignited with the first liquid fuel, has a relatively low evaporation enthalpy. Thus, the distance of the relatively ignitable first liquid fuel to the relatively less ignitable second liquid fuel can be minimised during the injection of the liquid fuels in order to increase the power and reduce emissions.

Longitudinal centre axes of the first channels 17 and second channels 22 diverging in the flow direction are advantageously employed in particular when the second liquid fuel, which is to be ignited with the first liquid fuel, has a relatively high evaporation enthalpy. Thus, an excessive cooling in the region of the first liquid fuel can be avoided in order to ensure a secure ignition.

In the exemplary embodiment of FIG. 1, both needle guides 13, 18 and both needle fuel chambers 15, 20 are integral parts of the main body 12. In this case, the main body 12 provides the two needle guides 13, 18 and the two needle fuel chambers 15, 20. In this case, the fuel injector 11 is preferentially produced by 3D printing with a preferentially following mechanical reworking and/or following heat treatment.

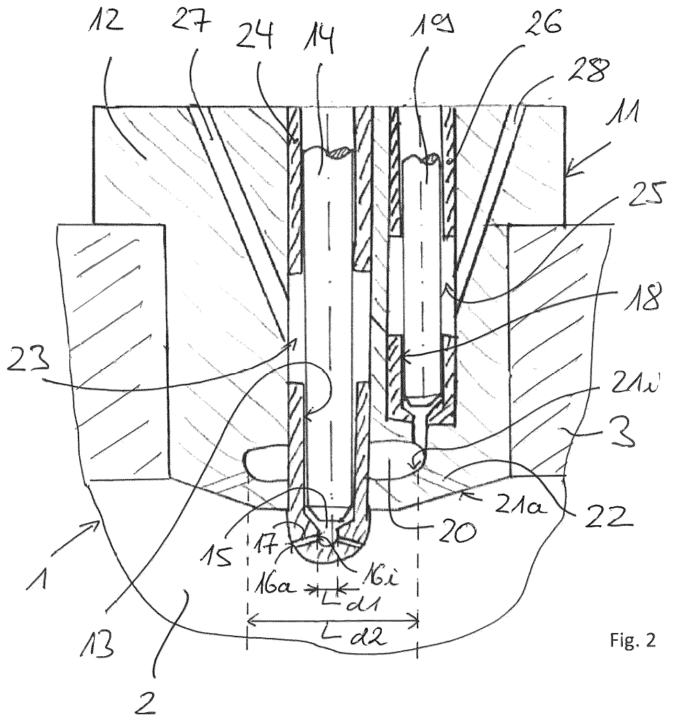

Compared with this, FIG. 2 shows in a schematic manner an exemplary embodiment of a fuel injector 11 which is composed of multiple individual parts. In FIG. 2, the main body 12 comprises a recess 23 in which a first insert 24 is arranged. This first insert 24 provides the first needle guide 13 for the first nozzle needle 14, the first needle fuel chamber 15, the first channels 17 and the first openings 16i, 16a.

The main body 12 provides the second needle fuel chamber 20, the second channels and the second openings 21i, 21a, wherein the first insert 30 delimits or seals the second needle fuel chamber 20 radially inside.

Preferentially, the main body 12 comprises a second recess 25 in which a second insert 26 is arranged. The second insert 26 provides the second needle guide 18 for the second nozzle needle 19.

Via fuel bores 27, 28, which are not shown in FIG. 1, the respective fuel can be conducted in the direction of the respective nozzle needle 14, 19.

In the embodiment of FIG. 2 it is provided in particular to produce the inserts 24, 26, which interact with the nozzle needles 14, 19, from a different metallic material than the main body 12.

Furthermore, the disclosure relates to an internal combustion engine with cylinders 1, wherein each cylinder 1 comprises a fuel injector 11 according to the invention. As already explained, a homogeneous or even mixture propagation can be ensured in the combustion chamber 2 of the respective cylinder 1 in particular when in the cylinder 1 of the internal combustion engine a relatively less ignitable fuel such as for example methanol, ethanol or ammonia is to be combusted and ignited with a relatively ignitable liquid fuel, such as a diesel fuel, which is advantageous in particular for a combustion method according to a diesel-engine combustion principle. However, the fuel injector 11 according to the invention can also be employed with spark-ignition combustion methods.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A fuel injector of an internal combustion engine configured to supply fuel to a combustion chamber of a cylinder of the internal combustion engine, comprising:
a main body;
a first nozzle needle moveably guidable in a first needle guide;
a first needle fuel chamber that interacts with the first nozzle needle for a first liquid fuel, which can be coupled via first channels to the combustion chamber of the cylinder, wherein the first channels are connected to the first needle fuel chamber via first internal openings;
a second nozzle needle moveably guided in a second needle guide; and
a second needle fuel chamber that interacts with the second nozzle needle for a second liquid fuel, which can be coupled via second channels to the combustion chamber of the cylinder, wherein the second channels are connected to the second needle fuel chamber via second inner openings;
wherein the first internal openings are arranged on a first circular contour and the second inner openings on a second circular contour extending concentrically about the first circular contour.

2. The fuel injector according to claim 1,
wherein the second needle fuel chamber is arranged, at least in portions, concentrically about the first needle fuel chamber.

3. The fuel injector according to claim 1,
wherein longitudinal centre axes of the first channels are parallel to longitudinal centre axes of the second channels.

4. The fuel injector according to claim 1,
wherein longitudinal centre axes of the first channels and longitudinal centre axes of the second channels, seen in a flow direction, diverge.

5. The fuel injector according to claim 1,
wherein longitudinal centre axes of the first channels and longitudinal centre axes of the second channels, seen in a flow direction.

6. The fuel injector according to claim 1,
wherein a ratio (d1/d2) between a first diameter of the first circular contour and a second diameter of the second circular contour is between at least one of:
0.1 and 0.5, and
0.2 and 0.3.

7. The fuel injector according to claim 1,
wherein the main body comprises a first recess, in which a first insert is arranged,
wherein the first insert is configured as the first needle guide for the first nozzle needle, the first needle fuel chamber, and the first channels.

8. The fuel injector according to claim 7,
wherein the main body provides the second needle fuel chamber and the second channels.

9. The fuel injector according to claim 7,
wherein the main body comprises a second recess, in which a second insert is arranged,
wherein the second insert is configured as the second needle guide for the second nozzle needle.

10. The fuel injector according to claim 1,
wherein the first liquid fuel serves for igniting a second fuel.

11. An internal combustion engine, comprising:
a cylinder equipped for igniting, with a first fuel, a second fuel for combustion in the cylinder; and
a fuel injector for the cylinder comprising:
a main body;
a first nozzle needle moveably guidable in a first needle guide;
a first needle fuel chamber that interacts with the first nozzle needle for a first liquid fuel, which can be coupled via first channels to a combustion chamber of the cylinder, wherein the first channels are connected to the first needle fuel chamber via first internal openings;
a second nozzle needle moveably guided in a second needle guide; and
a second needle fuel chamber that interacts with the second nozzle needle for a second liquid fuel, which can be coupled via second channels to the combustion chamber of the cylinder, wherein the second channels are connected to the second needle fuel chamber via second inner openings;
wherein the first internal openings are arranged on a first circular contour and the second inner openings on a second circular contour extending concentrically about the first circular contour.
